(19) United States
(12) Patent Application Publication
(10) Pub. No.: US 2009/0307486 A1
(43) Pub. Date: Dec. 10, 2009

(54) SYSTEM AND METHOD FOR SECURED NETWORK ACCESS UTILIZING A CLIENT .NET SOFTWARE COMPONENT

(76) Inventors: Garret Grajek, Aliso Viejo, CA (US); Stephen Moore, Portland, OR (US); Mark Lambiase, Ladera Ranch, CA (US)

Correspondence Address: STETINA BRUNDA GARRED & BRUCKER, 75 ENTERPRISE, SUITE 250, ALISO VIEJO, CA, 92656, US

(21) Appl. No.: 12/135,466

(22) Filed: Jun. 9, 2008

(51) Int. Cl. H04L 9/32

(52) U.S. Cl. 713/156

(57) ABSTRACT

A method for self-service authentication of a client and a server. The method includes the server receiving an initialization command from the client. The initialization command may be transmitted to the server via a client web browser over an unsecured data transfer link. The method continues with requesting authentication information from the client. In response to receiving the authentication information from the client, the server transmits a client software component to the client. The client software component utilizes a client-side library installed on the operating system of the client to generate the various client credentials described above. Thereafter, the certificate signing request may be transmitted to a certificate server for signing the certificate signing request. The signed certificate signing request is then received by the client via the client web browser. The client utilizes the information associated with the signed certificate signing request with the client-side library installed on the client to generate a client certificate.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention generally relates to methods and systems for authentication in secure data communications. More particularly, the present invention relates to methods and systems for authenticating a client and a server through a smart client component.

2. Related Art

Electronic transactions may involve a server computer system and a client computer system communicating over a network. In an open network environment, data security and integrity is a vital component associated with network communications. The server computer must be assured that the client is what it asserts it is. The client must be assured that the server computer is what it asserts it is. Any information exchanged between a legitimate server and a legitimate client must not be intercepted or altered by any other computer systems on the network. Public Key Infrastructure (PKI) arrangements enable a client computer system without prior contact with a server computer system to authenticate the client and the server to each other. Authenticating the client and the server to each other establishes a precedent for transmitting encrypted messages between the client and the server.

PKI in cryptography is an arrangement that binds public keys with respective client identities by means of a Certificate Authority (CA). The client identity must be unique for each CA. The binding of public keys with respect to client identities may be carried out by software hosted by the CA, under human supervision, or with other coordinated software at distributed locations. PKI and digital certificates enable identification of a client and a server and communication over an unsecured network such as the Internet.

Securing sensitive information is highly desirable with respect to the financial industry. In the electronic banking setting, for example, the bank must authenticate the identity of the client accessing the banking server, so that transactions relating only to a particular customer are permitted, and that client accessing the banking server is verified as the customer or someone given authority by the customer. The client must be ensured that the banking server is, indeed, the server operated by the bank, and not a similar one operated by a malicious entity. This is known as a phishing attack, where a fake server is made to resemble the legitimate server, and manipulates the user into providing confidential information such as bank account numbers, social security numbers, passwords, and the like. Much harm may be inflicted on the customer by a criminal possessing such information, including erroneous accumulation of debt, arrest records, criminal convictions, destruction of creditworthiness, damage to reputation, and so forth. These are also known as identity theft crimes. Because confidential information is being transmitted over an open network, such information must be encrypted or otherwise rendered incomprehensible to any other system besides the client and the server. The open nature of the network renders computer systems susceptible to replay attacks, where a valid data transmission is intercepted and repeated later for fraudulent or malicious purposes. For example, passwords or other authentication information may be intercepted, and used later to gain access to sensitive information. Further, the information being transmitted on the network must not be modifiable, such as in the case of man-in-the-middle attacks. This involves an attacker reading, inserting and modifying data between a legitimate client and a server with neither recognizing the compromised nature of the link.

Generally, these security considerations are of primary importance in all networking environments where sensitive and/or confidential data is being exchanged. Many business organizations currently utilize Virtual Private Networks (VPNs) for secure remote access via public networks such as the Internet to the organization's internal network resources. Without proper safeguards that prevent the above-described attacks, the security of the organization's data as well as the organization's customers' or clients' data may be compromised, leading to even greater losses than that affecting an individual.

In PKI, a digital certificate is comprised of various data components used to identify a client, encrypt data, decrypt data, or digitally sign data. A valid digital certificate includes a public key, a private key, and validation information. One method for generating and distributing digital certificates by a client includes generating a private key and a public key (also known as a key pair), generating a certificate signing request (CSR), and validating the certificate credentials by a trusted source. The validation or enrollment process occurs when the CSR is signed by the trusted source. Another method includes the client receiving a fully formed certificate. However, if the fully formed certificate is intercepted, the confidentiality of the private key may be compromised. Once the private key is compromised the digital certificate is useless. The interceptor of the fully formed certificate may impersonate the client for which the certificate was intended for.

Generally, public key encryption involves a unique public/private key pair held by both the recipient and the sender. The private key of the sender is retained solely by the sender, and the private key of the recipient is retained solely by the recipient. The public key of the sender is distributed and is held by the recipient, and the public key of the recipient is also distributed and held by the sender. When transmitting a message, the sender's private key and the recipient's public key is used to encrypt the message. The message is decrypted by the recipient using the recipient's private key and the sender's public key. The recipient need not have a unique public/private key pair, however, and instead may utilize a one-time cipher. The key pair utilizes algorithms that are called asymmetric key cryptography. In asymmetric key cryptography, data encrypted by the public key can only be decrypted by the private key, and data encrypted by the private key can only be decrypted by the public key. As such, in the transmission of a private message or data to a system, encryption with the public key provides confidentiality to the data or message because no other user or system without access to the private key may decrypt the data or message.

A variety of techniques are used to authenticate, or verify the identity of the client. Authentication may utilize one or more factors, which include something a user knows, something a user has, and something a user is. To authenticate the server computer system or other like networked resource, and to ensure that data transmissions are not intercepted, the Transport Layer Security (TLS) protocol is frequently utilized. TLS is a cryptographic protocol that provides data exchanges safe from eavesdropping, tampering, and forgery, and is often used for securing web browsing, e-mail, file transfers, and other such electronic transactions. More particularly, TLS operates on the protocol layers below the application-layer protocols such as the HyperText Transfer Protocol (HTTP), File Transfer Protocol (FTP), Simple Mail Transfer Protocol (SMTP), but above the transport level protocols such as the Transmission Control Protocol (TCP) or the User Datagram Protocol (UDP).

TLS is commonly implemented only on a server-side basis, however, and only the server is authenticated. For example, when establishing a secure HyperText Transfer Protocol (HTTP) connection or a secure VPN connection from a client web browser to a web server or other network resource, the client browser retrieves a digital certificate associated with the web server. The digital certificate contains the public key and is used by the web browser to authenticate the identity of the web server or network resource, and to encrypt a session key transmitted back thereto for use in encrypting subsequent data. In order to ensure the legitimacy of the server certificate, it is signed by the CA.

Though the implementation of client-side TLS establishes a bilateral trust between the server/network resource and the client and prevents identity theft and phishing attacks, there are a number of significant deficiencies. More particularly, it is necessary for the client to obtain or purchase a certificate properly signed by the CA. Thus, complications associated with certificate ownership are placed on the client. Additionally, implementing client authentication on the server or network resource is a cumbersome process, in that additional servers and maintenance are necessary. In addition to the other core functionality provided by the server, it must be configured to issue client certificates. Further, a method for authenticating the client and the server utilizing client-side libraries, including Java, NET, Flash and/or Microsoft's SilverLight installed on the client operating system has proven challenging.

Accordingly, there is a need in the art for an improved method and system for authenticating the client and network resources such as web servers, VPN links, and the like without the use of hardware devices or the deployment of client-side TLS.

### BRIEF SUMMARY

In accordance with one embodiment of the present invention, there is provided a method for self-service authentication of a client and a server. The method includes the server receiving an initialization command from the client. The initialization command may be transmitted to the server via a client web browser over an unsecured data transfer link. The method continues with requesting authentication information from the client. The client then transmits the authentication information to the server via the client web browser. The authentication information may include any information that verifies the client to the server. In response to receiving the authentication information from the client, the server transmits a client software component to the client. The client software component is processed by the client to generate a client private key, a client public key, and a certificate signing request. The client software component utilizes a client-side library (e.g., .NET smart client, Flash, Java Applet, SilverLight) pre-installed on the operating system of the client to generate the various client credentials described above. In one embodiment, the client software component is an executable code transmitted from the server to the client. The executable code may be received by the client via the client web browser. The executable code is configured to utilize the client-side libraries stored by the operating system located on the client. Thereafter, the certificate signing request may be transmitted to a certificate server for signing the certificate signing request. The signed certificate signing request is then received by the client via the client web browser. The client utilizes the information associated with the signed certificate signing request with the client-side library installed on the client to generate a client certificate. The client certificate may then be used for secure transactions between the client and the server.

In another embodiment of the present invention, the server communicates with a database to verify the authentication information submitted by the client. The database contains the authentication information provided by the client through a prior registration process. Therefore, the authentication information from the client may be compared with the authentication information stored on the database to verify the client is providing accurate information. An aspect of the present invention contemplates the database being hosted on the server. In another embodiment of the present invention, the server is in communication with a telephony server. In this respect, the client may submit to the server an out of band modality for which to transmit a onetime pass-code for authentication purposes. For example, if the client requests the out of band modality to be via telephone, the client provides the server a telephone number. The server is then in communication with a telephony server to instruct the telephony server to transmit a onetime pass-code to the telephone number provided by the client. Thus, the out of band method is independent of the unsecured data transfer link between the client and the server. After receiving the onetime pass-code from the telephony server, the client may use the pass-code for authentication of the client to the server. An aspect of the present invention contemplates the server being a secure sockets layer virtual private network. The secure sockets layer virtual private network may be in communication with the database for authenticating the client.

In accordance with another aspect of the present invention, there is provided a system for self-service client authentication. The system includes a client computer having a client web browser for transmitting a certificate signing request generated on the client computer. The system also includes a server computer. The server computer is in communication with the client computer for establishing a multiple factor authentication of the client computer. The system also includes a software component hosted on the client computer. The software component utilizes a client-side library or libraries on the client computer for generating various client credentials. The client credentials generated by the software component processing the client-side libraries include a client private key, a client public key, and the certificate signing request. The various client credentials are generated in response to the multiple factor authentication of the client computer. The system also includes a certificate server for signing the certificate signing request generated by the client computer. It is contemplated that the multiple factor authentication includes requesting authentication information from the client computer. The authentication information provided by the client may be compared with information stored on a database for verification purposes. The system may include the server computer transmitting authentication information via an out of band modality through a telephony server or a text message server for example. Additionally, authentication information from the client computer transmitted to the server computer may include responses to knowledge based questions. It is contemplated that the software component is an executable code transmitted to the client computer from the server computer. The executable code comprising the software component may be processed by the client web browser to automatically generate a client certificate in response to receiving the signed certificate signing request.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating an environment in which one aspect of the present invention may be implemented, including various interconnected servers, clients and Virtual Private Networks (VPNs);

FIG. 2 is a flowchart illustrating a method for bi-directionally authenticating a client and a server in accordance with an aspect of the present invention;

FIG. 3 is a sequence diagram illustrating the exchange of data for authenticating the client and the server;

FIG. 4 is a sequence diagram illustrating the establishment of a Transport Layer Security (TLS) connection between the client and the server;

FIG. 5 is one embodiment of a digital certificate in accordance with an aspect of the present invention including various subparts thereof;

FIG. 6 is one embodiment of a response packet including a user certificate, a full requested URL, a token, and a server certificate;

FIGS. 7a-c is a flowchart illustrating the verification of the response packet; and

FIG. 8 is an exemplary configuration of the mutually authenticating client and server where the certificate and telephony servers are controlled by a third party provider.

### DETAILED DESCRIPTION

The detailed description set forth below in connection with the appended drawings is intended as a description of an embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the scope of the invention. It is further understood that the use of relational terms such as first and second, and the like are used solely to distinguish one from another entity without necessarily requiring or implying any actual such relationship or order between such entities.

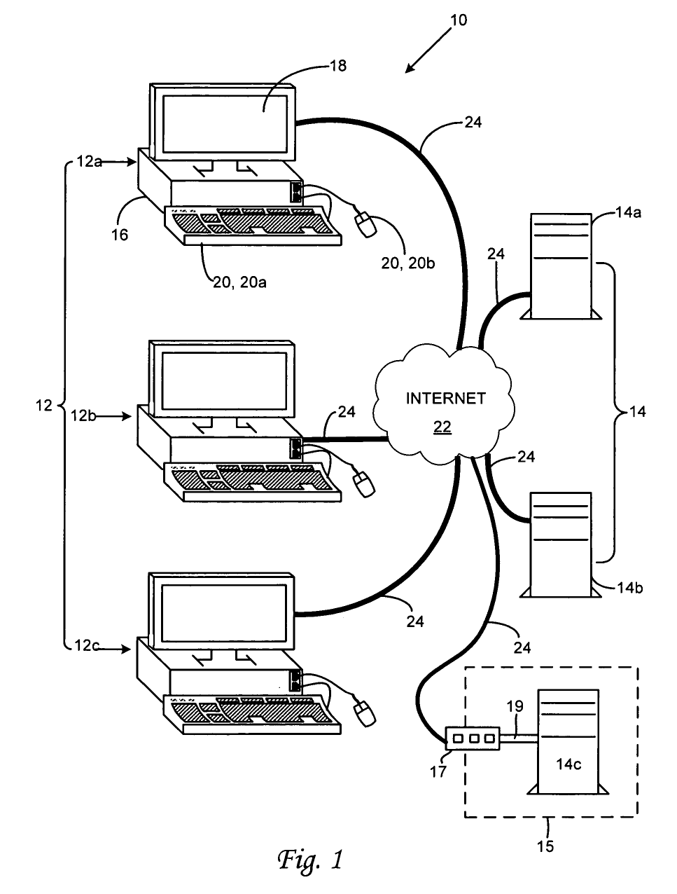

With reference to FIG. 1, an exemplary computer network 10 includes various data processing apparatuses or computers 12, 14. More particularly, the computers 12 may be personal computers or workstations that function as clients, and include a system unit 16 that houses a central processing unit, storage devices, and the like. The computers 12 may also include a display unit 18, and input devices 20 such as a keyboard 20a and a mouse 20b. It is understood that the system unit 16 receives various inputs from the input devices 20 that alter the control and flow of preprogrammed instructions being executed by the central processing unit, and the results of such execution are shown on the display unit 18. The computers 14 may be servers that provide data or services to the client computers 12. In this regard, the term “client” is understood to refer to the role of the computers 12 as a requester of data or services, while the term “server” is understood to refer to the role of the servers 14 to provide such data or services. Additionally, it is possible that the computers 12 may request data or services in one transaction and provide data or services in another transaction, thus changing its role from client to server or vice versa. It is further understood that the term “server” as utilized herein may also refer generally to networked services such as a Secure Sockets Layer/Transport Layer Security (SSL/TLS) Virtual Private Network (VPN), through which conventional servers 14 provide data and applications to remote clients.

The computers 12, 14 are connected to a wide area network such as the Internet 22 via network connections 24. Requests from the client computers 12 and requested data from the server computers 14 are delivered through the network connections 24. According to an embodiment of the present invention, the server computers 14 are web servers, and the client computers 12 include web browsing applications such as Microsoft Internet Explorer, Mozilla Firefox, or Netscape Navigator that visually render documents provided by the server computers 14 on the display unit 18. It will be appreciated that the network topology shown in FIG. 1 is presented by way of example only and not of limitation, and any other type of local or wide area network may be readily substituted without departing from the scope of the present invention. It is understood that any well known data transmission protocol may be utilized for the network connections 24 and the Internet 22.

As a further example, a first server computer 14a may be an electronic banking web server that provides account information and funds transfer functionality. Additional uses are also contemplated, where the first server computer 14a hosts a mail server, an online shopping site, or a Microsoft NET application. A user on the first client computer 12a may log on to the first server computer 14a to retrieve the account balance and transfer funds to a separate account using a client web browser. In this exemplary context, one of the considerations of information security includes ensuring that the user on the first client computer 12a is who he asserts to be. For example, a malicious user on a second client computer 12b may have all of the credentials of the user on the first client computer 12a to log on to the first server computer 14a without recognizing that such access is fraudulent. A second consideration includes ensuring that the first server computer 14a is under the control of a bank of which the user on the first client computer 12a is a customer. It may be possible that the second server computer 14b is imitating the first server computer 14a in a phishing attempt, and the first client computer 12a may have been misdirected to the second server computer 14b. Additionally, all legitimate data transfers between the first client computer 12a and the first server computer 14a must not be intercepted by any other computers, including a third client computer 12c, the second client computer 12b, and the second server computer 14b.

As indicated above, instead of a specific server computer 14a, the clients 12 may access a VPN 15. The VPN 15 may be connected to the Internet 22 via a VPN router 17 for permitting remote access to the clients 12. It is understood that the VPN router 17 is the only modality through which outside clients 12 may access a server 14c on a local network 19. The same security concerns noted above are equally applicable to the VPN 15, and thus it is contemplated that the methods and systems of the present invention may be implemented therefore, as will be described in further detail below.

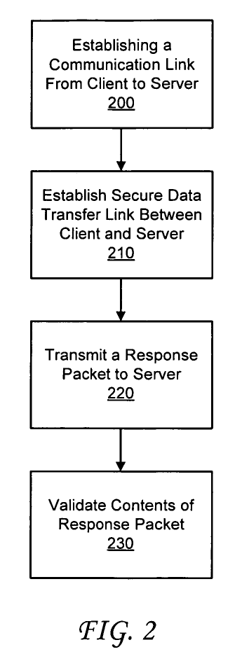

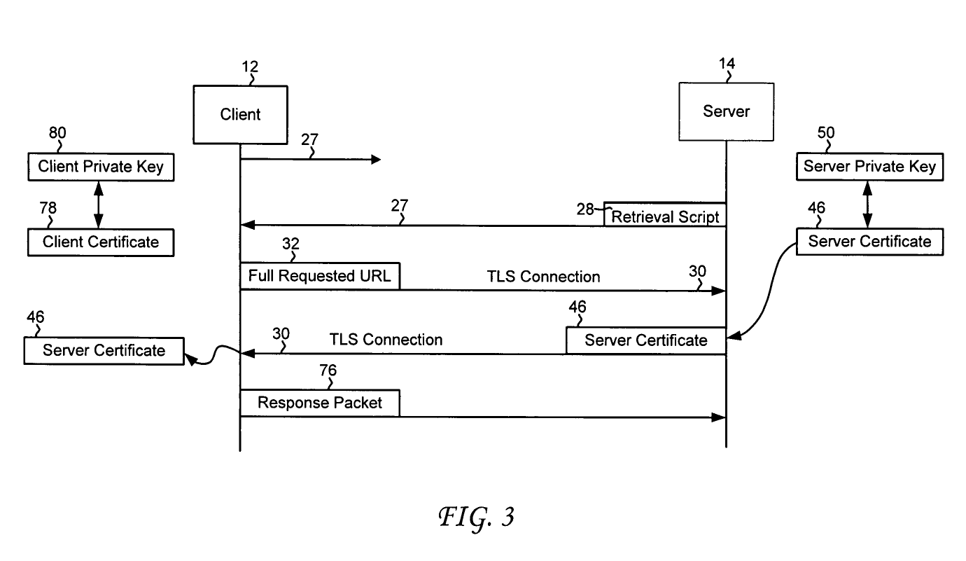

An aspect of the present invention relates to a method of mutually authenticating the client computer 12 and the server computer 14. With reference to the flowchart of FIG. 2 and additionally to the sequence diagram of FIG. 3, the method initiates with a step 200 of establishing a communication link 27 from the client computer 12 to the server computer 14. For example, the user of the client computer 12 may input the network address of the server computer 14 into the client web browser application on the client computer 12, at which point a request is made for a file or page on the server computer 14. The server 14 is configured to receive an initialization command from the client 12 over an unsecured data transfer link. According to one embodiment of the present invention, the server 14 transmits a certificate retrieval script 28 to the client 12, which directs the client web browser to begin the process of authenticating the client computer 12.

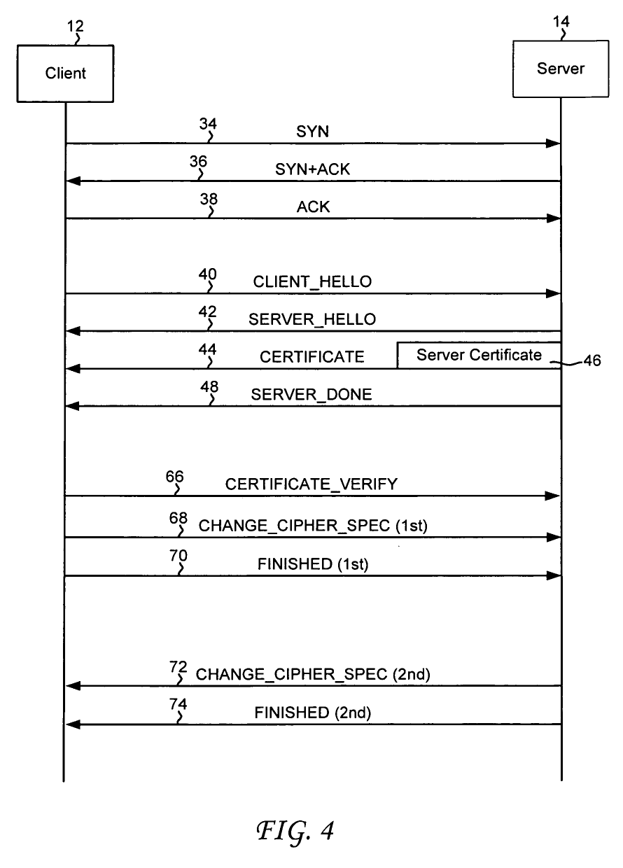

Thereafter, according to step 210, a secure data transfer link 30 is initiated by the client computer 12 utilizing a full requested Uniform Resource Locator (URL) 32. In accordance with an embodiment of the present invention, the secure data transfer link 30 is a symmetric TLS link. In further detail with reference to the sequence diagram of FIG. 4, the client computer 12 initiates a connection to the server computer 14 by transmitting a synchronize, or SYN packet 34. Thereafter, the server computer 14 transmits a synchronize and acknowledge, or SYN+ACK packet 36 to the client computer 12. Upon receipt, the client computer 12 re-sends an acknowledge, or ACK packet 38 to the server computer 14. As understood, the foregoing transmissions relate to the Transmission Control Protocol (TCP), a protocol layer underneath the TLS protocol.

Upon establishing a TCP connection between the client computer 12 and the server computer 14, a CLIENT_HELLO command 40 is sent from the client computer 12 to the server computer 14. This packet includes the highest version of TLS supported by the client computer 12, the ciphers and data compression methods supported by the client computer 12, a session identifier, and random data. Upon receipt of the CLIENT_HELLO command 40, the server computer 14 transmits a SERVER_HELLO command 42. The SERVER_HELLO command 42 includes the version of TLS, cipher, and data compression method that has been selected. Additionally, the previously set session identifier is included, as well as additional random data. Thereafter, the server computer 14 transmits the CERTIFICATE command 44, which includes a server certificate 46, and a SERVER_DONE command 48, which indicates that the server computer 14 has completed this handshaking phase.

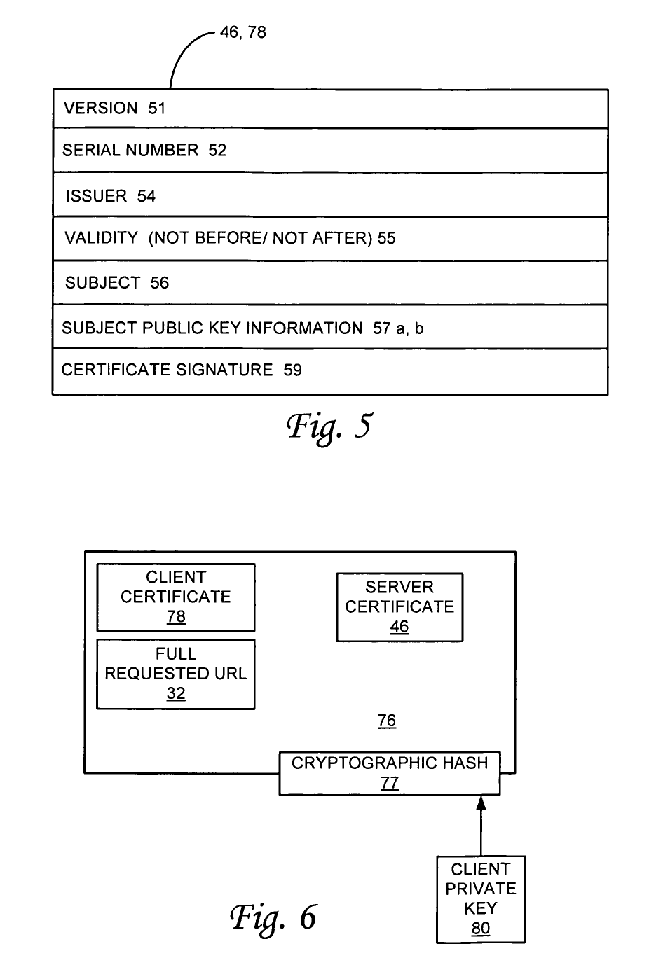

The server certificate 46 is understood to be in conformance with the X.509 standard. More particularly, with reference to FIG. 5, the data stored in the server certificate 46 includes a version number 51, a serial number 52, an issuer identifier 54, a validity identifier 55, a subject 56, a subject public key information 57 including a public key algorithm identifier 57a and a subject public key 57a,b, and a certificate signature 59. The version number 51 identifies the version of the X.509 standard being used for the particular certificate, while the serial number 52 is a unique number assigned by a particular CA. The issuer identifier 54 includes the name of the CA that issued the certificate, and a validity identifier 55 includes a validity date range with earlier and later limits. The subject identifier 56 contains the name of a person, group, or organization to which the certificate was issued. The subject public key algorithm identifier 57a denotes the algorithm used to generate the subject public key 57b, and the subject public key 57b contains the public key associated with the certificate 46. The certificate signature 59 contains a signature as generated by the CA. As further understood, the server certificate 46 includes a corresponding server private key 50.

Referring back to FIG. 4, after verifying the authenticity of the sever certificate 46, the client computer 12 transmits a CERTIFICATE_VERIFY command 66. Additionally, the client computer 12 transmits a first CHANGE_CIPHER SPEC command 68, followed immediately by a first FINISHED command 70. This indicates that the contents of subsequent TLS record data sent by the client computer 12 during the current session will be encrypted. It is understood that the first FINISHED command 70 includes a digest of all handshake commands previously transmitted to ensure that no alteration occurred. Next, the server computer 14 transmits a second CHANGE_CIPHER_SPEC command 72, followed immediately by a second FINISHED command 74. Like the first CHANGE_CIPHER_SPEC command 68, the second CHANGE_CIPHER SPEC command 72 indicates that subsequent TLS record data sent by the server computer 14 during the current session will be encrypted. The second FINISHED command 74 includes all prior handshake commands from the server computer 14 to the client computer 12. The client computer 12 transmits a generated symmetric key that is encrypted with the subject public key 57b in the server certificate 46. The server private key 50 is used to decrypt to the symmetric key upon receipt by the server computer 14, and subsequent transmissions to the client computer 12 will be encrypted therewith.

As indicated above, the client computer 12 securely retrieves the server certificate 46 in accordance with an aspect of the present invention. Specifically, according to the process of establishing the TLS connection 30 between the client computer 12 and the server computer 14, the server certificate 46 is transmitted. In one embodiment, the client computer 12 stores the server certificate 46 for use outside the context of the TLS connection 30, as will be detailed further below.

Referring back to FIGS. 2 and 3, the method for mutually authenticating the client computer 12 and the server computer 14 continues with a step 220 of transmitting a response packet 76 to the server computer 14. In further detail as shown in FIG. 6, the response packet 76 is comprised of the full requested URL 32, the server certificate 46, and a client certificate 78. The structure of the client certificate 78 is identical to that of the server certificate 46, and as shown in FIG. 5, includes the version 51, the serial number 52, the issuer 54, the validity identifier 55, the subject identifier 56, the subject public key information 57a,b, and the certificate signature 59. According to one embodiment of the present invention, the NET libraries on the client 12 operating system are utilized to retrieve the client certificate 78 from a certificate storage location. Like the server certificate 46, the client certificate 78 also has a corresponding private key, a client private key 80. The response packet 76 includes an additional authentication identifier correlated to the client private key 80. According to one embodiment of the present invention, such authentication identifier is a cryptographic hash 77 of the contents of the response packet 76. By way of example only and not of limitation, the Message Digest Algorithm-2 (MD2) hash function is used, though any other hash function such as Message Digest Algorithm-5 (MD5), Secure Hash Algorithm (SHA) or the like may be substituted without departing from the scope of the present invention. The resulting cryptographic hash 77 is signed with the client private key 80.

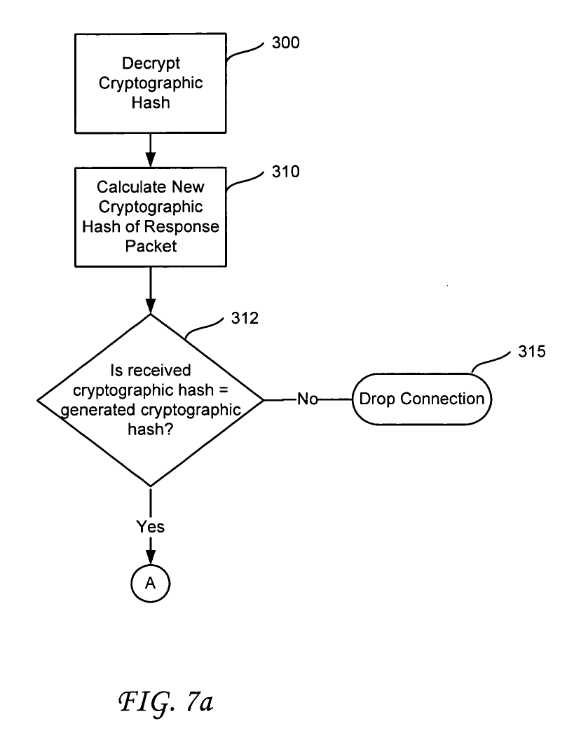

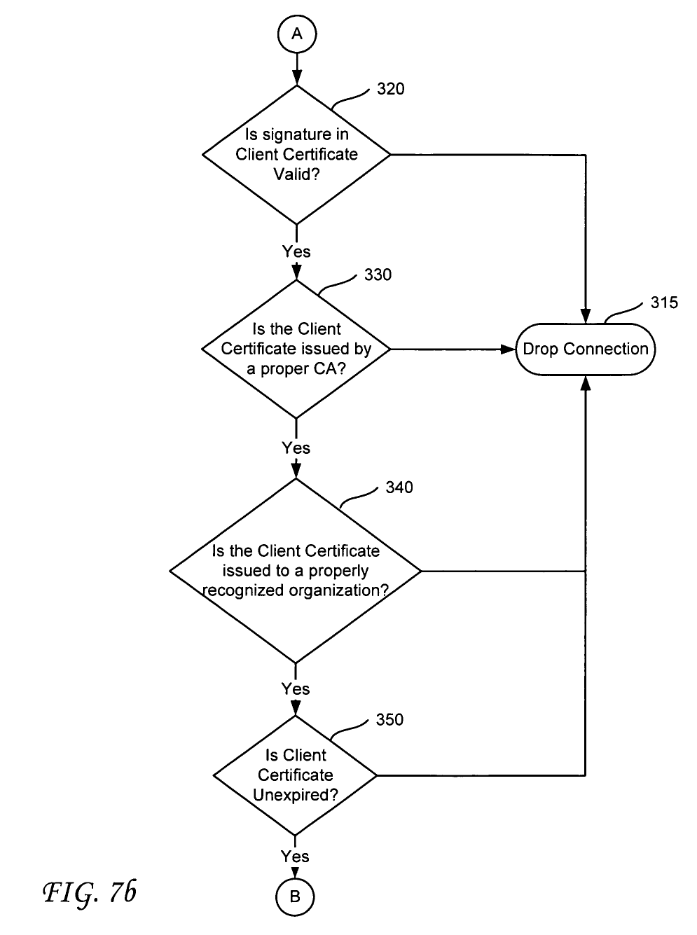

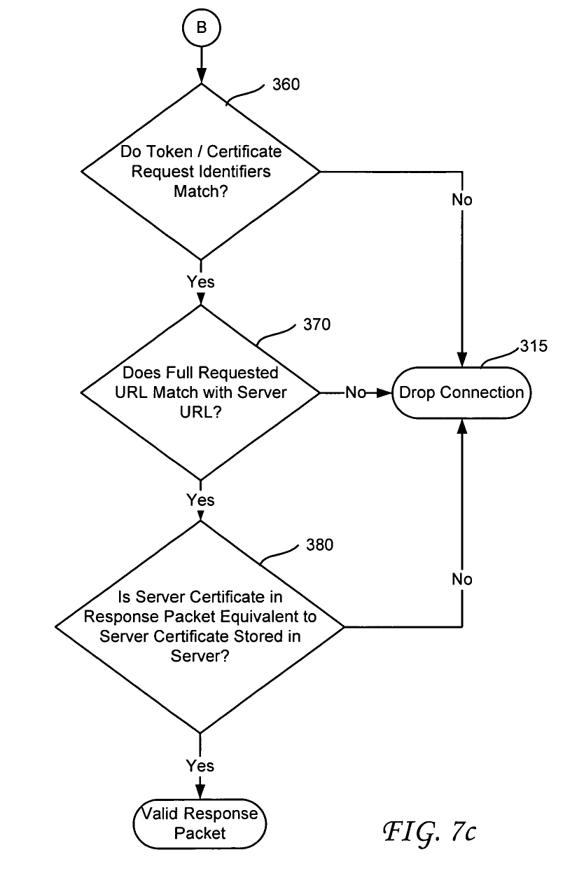

According to step 230, the method further includes validating the contents of the response packet 76. First, the authenticity of the response packet 76 is verified. As indicated above, the response packet 76 includes the cryptographic hash 77 that has been signed with the client private key 80. With reference to the flowchart of FIGS. 7a-7c, according to step 300, the client-side cryptographic hash 77a is decrypted using the client certificate 78. A server-side cryptographic hash is computed for the response packet 76 as existing on the server 14. The server-side cryptographic hash is compared against the client-side cryptographic hash 77 accompanying the response packet 76 per comparison step 312. If the values do not match, then the response packet 76 is deemed to have been tampered with, and any connections are terminated as in step 315. If the values match, further verification of the contents of the response packet 76 continues as will be described below.

Such further verification includes comparing the constituent parts of the response packet 76 with known copies thereof. First, the signature of the client certificate 78 is validated per step 320, where the subject public key information 57b is verified. Thereafter, the certificate signature 59 and the issuer identifier 54 are examined to confirm that a properly recognized CA has signed the client certificate 78 per step 330. The subject identifier 56 is also examined to confirm that the client certificate 78 was issued to a properly recognized organization according to step 340. According to one embodiment, a properly recognized organization refers to a legitimate organization having control over the server computer 14. Additionally, the client certificate 78 is confirmed to be valid and unexpired by comparing the validity identifier 55 of the client certificate 78 against the current date per step 350. If any of the foregoing validation steps fail, the client certificate 78 is deemed to have been tampered with, and drops the connection per step 315.

The remaining components in the response packet 76 are also verified, including the full requested URL 32 and the server certificate 46. It is understood that matching values confirms that no replay attacks are taking place. With respect to the full requested URL 32 in step 370 the value thereof is verified against the actual URL of the server computer 14. This is understood to verify that no phishing attacks are taking place that redirect the client computer 12 to a malicious server. With respect to the server certificate 46 included in the response packet 76, per step 380 it is compared against the server certificate 46 residing on the server computer 14. This prevents man-in-the-middle attacks. A malicious server will have a different server certificate 46 from the one stored on the server computer 14 which should match the server certificate 46 being returned via the response packet 76. Along these lines, if any of the foregoing verifications fails, the connection between the server computer 14 and the client computer 12 is immediately severed, and no further access to the server computer 14 is permitted. If there are no anomalies, however, the client computer 12 is authenticated and continues to access the server computer 14. As will be appreciated, the foregoing verifications discover one or more security breaches.

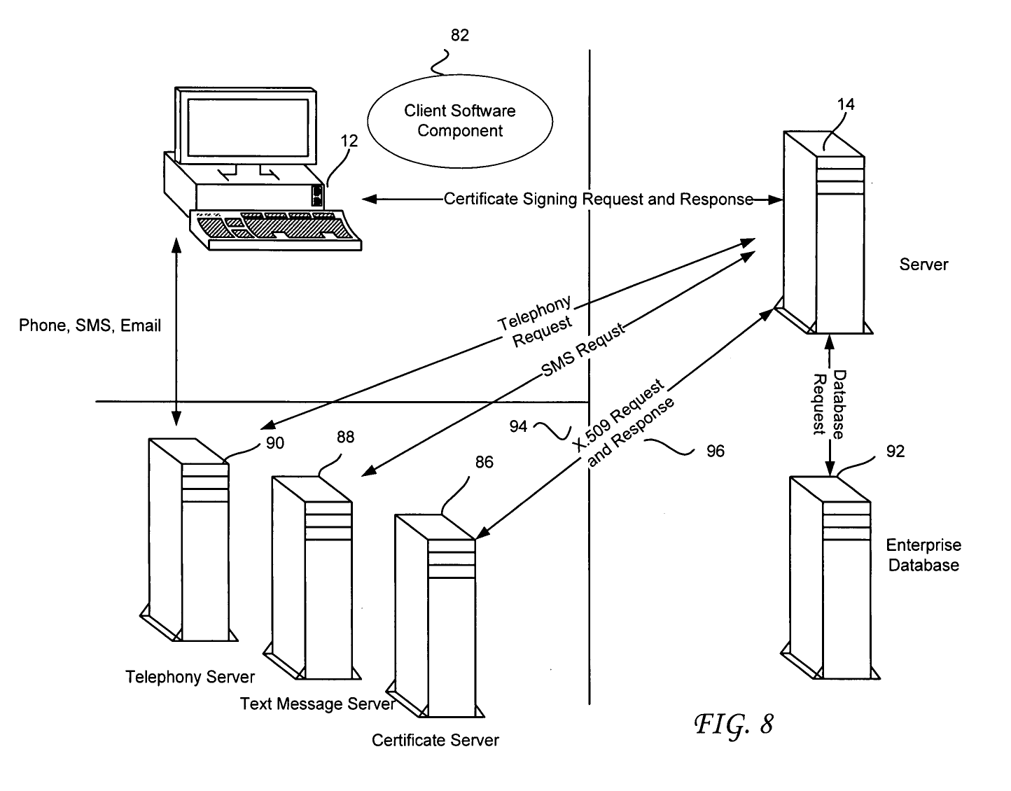

With reference to FIG. 8, according to another aspect of the present invention, the client 12 is authenticated and includes the ability to automatically generate the client private key 80, the client public key 57, and a certificate signing request 94. The client computer 12 includes a client software component 82. The client software component 82 is understood to handle the processes on the client side as discussed above, including retrieval of the script 28, the server certificate 46, and the client certificate 78, as well as the transmitting of the response packet 76 after signing the same with the client private key 80. According to one embodiment, the client software component 82 is an Active-X component that is installed with a single user interaction via the client web browser on the client computer 12. However, alternative executable components that may be added on to the client web browser are also deemed to be within the scope of the present invention. The client software component 82 can also be a Java Applett, an Adobe Flash Object, a Microsoft NET Smart Client, a Microsoft SilverLight client, or some other client component. Thus, the client software component 82 and the server 14 communicate with each other, and together implement an X.509 authentication scheme without the deployment of client-side TLS.

Prior to the client 12 generating the client private key 80, the client public key 57, and the certificate signing request 94, the client 12 may be required to successfully complete a multi-factor authentication process. The authentication process may be initiated after the establishment of the communication link 27 between the client 12 and the server 14 according to step 200. The server 14 directs the client to provide authentication information to be validated against a current data store. The request for authentication information may be in the form of a user login that requires a username and password. For example, after establishing the communication link 27, a request for the clients 12 username and password will appear via the client web browser. The client 12 then inputs the username and password, which is transmitted to the server 14 via the client web browser. The service 14 then validates the information provided by the client 12 from the data store located on the enterprise database 92. If the supplied information is correct, the multi-factor authentication process continues.

An aspect of the present invention contemplates an out-of-band authentication to enhance security and ensure strong authentication. For example, the server 14 may request from the client 12, a mobile phone number, a landline phone number, or an email address or any other out-of-band modality for delivering to the client 12 a onetime pass-code. Similar to the request for a username and password or any other authentication information requested, the information requested is submitted by the client 12 via the client web browser. The onetime pass-code is delivered to the client via an out-of-band modality provided by the client 12. Upon receipt of the onetime pass-code, the client 12 may input the pass-code via the client web browser. The server 14 may then authenticate the client 12.

Thereafter, the client 12 generates the client private key 80, the client public key 57, and the certificate signing request 94. This is accomplished by the client 12 NET libraries installed on the operating system processing the client software component 82. The client software component 82 is configured to be processed by the client 12 operating system without requiring user interaction. For example, the client private key 80, the client public key 57, and the certificate signing request 94 may automatically be generated on the client 12 side. In accordance with one embodiment of the present invention, the client software component 82 is configured to be processed by the client 12 operating system. The client 12 operating system may be a NET Framework or some other framework that allows the execution of client-side software code. The .NET Framework is a software component that is part of the Microsoft Windows operating systems. It has a large library of pre-coded solutions to common program requirements and manages the execution of programs written for the .NET Framework. The pre-coded solutions that form the framework's Base Class Library cover a large range of programming needs in areas including cryptography. Programs written for the .NET Framework execute in a software environment that manages the program's runtime requirements. This runtime environment, which is also a part of the .NET Framework, is known as the Common Language Runtime (CLR). The CLR provides the appearance of application virtual machine, so that programmers need not consider the capabilities of the specific CPU that will execute the client software component 82. The client software component 82 is configured to utilize the .NET libraries on the client computer 12 to create and validate the client certificate 78. It is contemplated that the client software component 82 utilizes the .NET libraries, or some other client-side libraries to create and validate the X.509 certificate and/or an X.509 certificate chain including the client certificate 78, an intermediate certificate, and a trusted root certificate. Additionally, the client software component 82 is configured such that it utilizes the native .NET runtime routines delivered in the Microsoft Vista platform for example. By utilizing these routines, the client computer 12 may quickly download the executable code on the client 12 operating system. Furthermore, the client software component 82 utilizes the NET libraries for executing and communicating between the client 12 and the server 14.

The client software component 82 transmits the certificate signing request 94 generated by the client 12 to the server 14 via the client web browser. The server 14 then transmits the certificate signing request 94 to a certificate server 86. The certificate server 86 validates the client certificate 78. In another embodiment of the present invention, it is contemplated that the client software component 82 may transmit the certificate signing request 94 directly to the certificate server 86. The certificate server 86 then issues a signed client certificate request 96. The signed client certificate request 96 is then transmitted to the client software component 82 via the client web browser and automatically installed on the client 12 utilizing NET libraries stored thereon.

One aspect of the present invention contemplates that the certificate signing request 94 is a Public Key Cryptography Standard (PKCS) #10. The certificate signing request 94 consists of three parts: certification request information, a signature algorithm identifier, and a digital signature on the certification request information. The certification request information consists of the entity's name, the entity's public key, and a set of attributes providing other information about the entity. The process by which a certification request is constructed involves the following steps: (1) a CertificationRequestInfo value containing a subject name, a subject public key, and optionally a set of attributes is constructed by an entity requesting certification. (2) The CertificationRequestInfo value is signed with the subject entity's private key. (3) The CertificationRequestInfo value, a signature algorithm identifier, and the entity's signature are collected together into a CertificationRequest value. A CA fulfills the request by authenticating the requesting entity and verifying the entity's signature, and, if the request is valid, constructing an X.509 certificate from the name and public key, the issuer name, and the CA's choice of serial number, and a valid duration period.

In accordance with an embodiment of the present invention, the certificate signing request 94 may not be transmitted to the server 14 prior to establishing the secure data transfer link between the client 12 and the server 14. The certificate signing request 94 may be in the form of a PKCS #10 request. An aspect of the present invention contemplates the PKCS #10 request being an X.509 certificate signing request 94. In one embodiment of the present invention, the certificate server 86 is a CA. The certificate server 86 is configured to digitally sign the certificate signing request 94. In another embodiment of the present invention, the certificate server 86 is a server remote from the client 12 and the server 14. In another embodiment of the present invention, it is contemplated that the certificate server 40 is hosted by the server 14.

Upon receiving the certificate signing request 94 at the certificate server 86, the next step may require generating a signed certificate signing request 96. The signed certificate signing request 94 generated at the certificate server 86 is transmitted in the form of a PKCS #7 response to the original PKCS #10 signing request requested by the server 14. The PKCS #7 response according to one embodiment of the present invention may be an X.509 certificate request response. The certificate request response is the signed certificate request 96. The next step proceeds with receiving the signed certificate request 96. The server 14 is in communication with the certificate server 86 and configured to receive the signed certificate request 96. Upon receiving the signed certificate request 96, the server component 14 transmits the signed certificate request 96 to the client 12. It is contemplated that the signed certificate request 96 is received on the client 12 via the client web browser.

The method continues with the client 12 generating the client certificate 78. The client software component 82 receives the PKCS #7 signed certificate request 96 that was signed by the certificate server 86. The client software component 82 generates the corresponding client certificate and public and private key pair with respect to the NET libraries installed on the client 12 operating system. The device receiving the client certificate may include the server 14, a virtual private network, a firewall, an e-mail system, or any device capable of utilizing a certificate for client SSL authentication.

It will be appreciated that the aforementioned authentication method presupposes that a client certificate 78 and a corresponding client private key 80 already exist on the client computer 12. The server 14 may determine whether or not the client certificate 78 exists on the client computer 12, and if not, the server 14 alerts the certificate server 86. Prior to issuing the client certificate 78 and the client private key 80 to the client computer 12, the user associated therewith is authenticated via an out-of-band modality. According to one embodiment, the server 14 notifies a telephony server 90 to deliver a one-time password to a cellular phone or a landline phone under the control of the client 12. Alternatively, an e-mail or a Short Message Service (SMS) text message may be sent from a text message server 88. Other out-of-band authentication techniques are contemplated, such as voice recognition, IP address verification, and the like. The entry of the one-time password may be handled through the server computer 14. In lieu of, or in addition to the foregoing out-of-band authentication, the client may be presented with an additional knowledge-based authentication. For example, the user may be asked about their favorite color, the high school they attended, and other similar questions.

Upon supplying the correct response, the server 14 directs the certificate server 86 to generate the client private key 80 and the corresponding client certificate 78, and store it on the client computer 12. The client certificate 78 may contain both identification and authorization information. In order to identify the particular user, the User ID, first name, last name, and employee identification information such as employee number may be incorporated into the client certificate 78. Further, authorization data such as enterprise name, organization name, workgroup, and other group-based permission system data may be incorporated into the client certificate 78. Additional authentication information may be stored in the enterprise database 92 for later retrieval and use by the server 14. It is understood that the foregoing procedure “registers” the client web browser on the client computer system 12 with the server computer 14, effectively making such browser a second authentication factor (“Something the user has”).

As indicated above, the issuer identifier 54 is examined to confirm that a properly recognized CA has issued and signed the client certificate 78. According to the embodiment shown in FIG. 8, the certificate server 86 is the CA, and is understood to be within the control of a legitimate third party provider separate from the organization managing the server computer 14 and the enterprise database 92. In an alternative embodiment, the certificate server 86 and the telephony server 90 are managed and maintained by the same organization managing the server computer 14. In yet another embodiment, secure access is being enabled for web services. As understood, the term web service refers to a standardized system for supporting machine to machine interaction. In this case, the client 12 utilizes the client software component 82 to authenticate with the server computer 14. The client certificate 78 thus generated is utilized to authenticate a W3 client with the web service via the client certificate 78.

In addition to the foregoing configurations, it is expressly contemplated that the client authentication device 82 and the server 14 may be integrated into a wide variety of applications requiring bi-directional authentication. By way of example only and not of limitation, these include .NET forms authentication in .NET applications, Microsoft Outlook Web Access, and Microsoft Sharepoint, as well as non-Microsoft web-based solutions and any other system with enforcement points that require proper client and server authentication.

In accordance with the present invention, it is contemplated that the automatic generation of the client private key 80, the client public key 57, and the certificate signing request 94 and the strong authentication of the client 12 may be accomplished through user self-service via the client web browser. Thus, eliminating the need for administrator resources to deploy software, install software upgrades or train end users on complex remote access procedures. Further, the system is fully portable, no additional servers are required, hard tokens are also not required. The client software component 82 has the ability to communicate with the server 14 to authenticate the client 12 via the client web browser. Additionally, the client software component 82 is configured to be processed by the client computer 12 automatically without requiring user input.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art how the several forms of the present invention may be embodied in practice.

What is claimed is:

1. A method for self-service authentication of a client and a server, the method comprising:
receiving on the server an initialization command from the client over an unsecured data transfer link;
requesting authentication information from the client;
transmitting a client software component from the server to the client in response to receiving authentication information from the client;
processing the client software component, the client software component being configured to evaluate a client-side library on the client for generating a client private key, a client public key, and a certificate signing request;
signing the certificate signing request on a certificate server; and
generating a client certificate corresponding to the signed certificate signing request on the client.

2. The method of claim 1, wherein the server is in communication with a database for verifying the authentication information.

3. The method of claim 1, wherein the database is hosted on the server.

4. The method of claim 1, wherein the server is in communication with a telephony server for issuing a onetime pass-code to the client independent of the unsecured data transfer link.

5. The method of claim 4, wherein the client utilizes the onetime pass-code for authentication of the client on the server.

6. The method of claim 1, wherein the client software component is an executable code transmitted to the client from the server.

7. The method of claim 1, wherein the server is a Secure Sockets Layer (SSL) Virtual Private Network (VPN).

8. The method of claim 1, wherein the client transmits the certificate signing request via the client web browser to the certificate server.

9. The method of claim 7, wherein the SSL VPN is in communication with a database for authenticating the client.

10. The method of claim 6, wherein the executable code transmitted to the client from the server is configured to utilize the client-side library installed on the client.

11. A system for self-service client authentication, the system comprising:
a client computer having a client web browser for transmitting a certificate signing request generated on the client computer;
a server computer in communication with the client computer for establishing a multiple factor authentication of the client computer;
a software component hosted on the client computer, the software component utilizing a client-side library on the client computer for generating a client private key, a client public key, and the certificate signing request in response to the multiple factor authentication of the client computer; and
a certificate server for signing the certificate signing request.

12. The system of claim 11, wherein the multiple factor authentication includes requesting authentication information from the client computer.

13. The system of claim 12, wherein authentication information from the client computer is validated with authentication information stored on a database.

14. The system of claim 12, further comprising transmitting authentication information from the server via an out of band modality.

15. The system of claim 12, wherein authentication information from the client computer transmitted to the server computer includes responses to knowledge based questions.

16. The system of claim 11, wherein the software component is an executable code transmitted to the client computer from the server computer.

17. The system of claim 16, wherein the executable code is processed by the client web browser to automatically generate a client certificate in response to receiving the signed certificate signing request.
